(19) United States
(12) Patent Application Publication
(10) Pub. No.: US 2014/0023528 A1
(43) Pub. Date: Jan. 23, 2014

(54) SYSTEM AND METHOD FOR REDUCING VIBRATION IN A FLUID PUMP

(71) Applicants: Mark M. Ayyad, Sanctuary Green (SG); Saravanan Velayutham, North Crescent (SG); Balamurugan Thangavelu, Srinivasannulur (IN)

(72) Inventors: Mark M. Ayyad, Sanctuary Green (SG); Saravanan Velayutham, North Crescent (SG); Balamurugan Thangavelu, Srinivasannulur (IN)

(73) Assignee: SCHLUMBERGER TECHNOLOGY CORPORATION, Sugar Land, TX (US)

(21) Appl. No.: 13/806,968

(22) PCT Filed: Jun. 24, 2011
(86) PCT No.: PCT/IB11/52787

§ 371 Date: Sep. 24, 2013

Related U.S. Application Data
(60) Provisional application No. 61/398,493, filed on Jun. 25, 2010.

(51) Int. Cl. F16F 15/00

(52) U.S. Cl. CPC F16F 15/00
USPC 417/364; 188/378; 29/888.02

(57) ABSTRACT

A system for dampening vibration in a pump includes a PTO-driven pump having a prime-mover side and a pump-side. The system includes a bulkhead interposed between the prime-mover side and the pump-side, the bulkhead having an opening therein. The system includes a vibration dampening plate having a thickness of at least 12 mm, where the vibration dampening plate is positioned between a bulkhead and a pump-side bearing flange or a prime-mover side bearing flange. The pump-side bearing flange or a prime-mover side bearing flange is coupled to the bulkhead at the opening therein. The system includes a bearing shaft extending through the opening in the bulkhead, the vibration dampening plate, the pump-side bearing flange, and the prime-mover side bearing flange.

### BACKGROUND

Some fluid pumps include a prime mover—for example an internal combustion engine—mechanically coupled to a pumping system. The mechanical coupling between the prime-mover and the pumping system includes a power take-off device, including a driveshaft on the pump-side and a driveshaft on the prime-mover side, if a bulkhead separates the engine and pump sides. Due to the excessive vibration that occurs in the oilfield pumping operation, the mechanical integrity of the pumping system may deteriorate over time, and it is often unclear as to its cause. Therefore, further design solutions are desirable in this area.

### SUMMARY

One embodiment is a unique apparatus for dampening vibration in a mechanical coupling between a prime-mover side and a pump-side of a fluid pump. Further embodiments, forms, objects, features, advantages, aspects, and benefits shall become apparent from the following description and drawings.

### BRIEF DESCRIPTION OF THE DRAWINGS

FIG. 1 is a schematic diagram of an exemplary vibration dampening plate.

FIG. 2 is a schematic diagram of a system including a prime-mover side, a pump-side, a mechanical coupling there between, and a vibration dampening plate.

### DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

The statements made herein merely provide information related to the present disclosure and may not constitute prior art, and may describe some embodiments illustrating the invention.

Embodiments disclosed herein are generally related to a pump engine assembly with reduced vibration. In particular, certain embodiments disclosed herein are related to centrifugal pumps that are commonly used to pressurize and transfer fluids in various applications.

Significant levels of sound and vibration are generated by the pumping unit. Fastening devices such as bolts and screws, especially in the mechanical coupling between the pump-side and the prime-mover side of the pumping unit, experience the generated vibration and are known to occasionally fail.

An exemplary pumping unit includes a flange of a driveshaft between a bulkhead and the driven pump. The bulkhead divides the prime-mover side of the pump from the hydraulic pumping side (pump-side). A set of connectors (typically 4 bolts) are employed to fasten the flange of the driveshaft to its companion flange. Another set of bolts (typically 4) are used to fit the wedge and the flange bearing to the bulkhead. The inclusion of the wedge is optional and exemplary only.

According to one aspect of the current application, a vibration reduction plate is positioned between the bulkhead and a bearing flange. The bearing flange may be pump-side bearing flange or the prime-mover side bearing flange, but in one embodiment the bearing flange is the pump-side bearing flange. The exemplary vibration reduction plate is secured to the bulkhead by fastening bolts extended through a number of holes provided around the outer edges of the plate. The plate reduces the vibration caused by the pump engine on the fastening bolts, especially the power take off (PTO) connectors, therefore improving the integrity and overall stability of the pump assembly. The plate can also function as a PTO connector strengthening plate, therefore further improving the integrity and overall stability of the pump assembly.

The plate can be of any thickness that is sufficient to reduce the vibration, and the specific thickness depends upon the material utilized and application-specific parameters such as the bulkhead thickness, level of vibration experienced at the coupling, the size of the driveline, and the power throughput of the PTO system. One of skill in the art, having the benefit of the disclosures herein, can readily determine a thickness that sufficiently reduces vibration. An exemplary plate is about 12.5 mm thick, and another exemplary plate is between 12 mm and 50 mm thick. The plate can be made of any material acceptable in the field.

One of skill in the art can select the material of the plate, having knowledge of the specific environment of the plate in a given application, including without limitation information about the vibration, temperature, pressure, exposure to elements, and chemical contact environment of the installed plate. In certain embodiments, the plate includes elastic materials such as rubber, plastics, and/or elastomeric materials. In certain embodiments, the plate includes laminated materials such as woven glass, epoxy, and/or composite materials. An exemplary plate includes a steel plate. The described materials are exemplary, and any other suitable functional material may used.

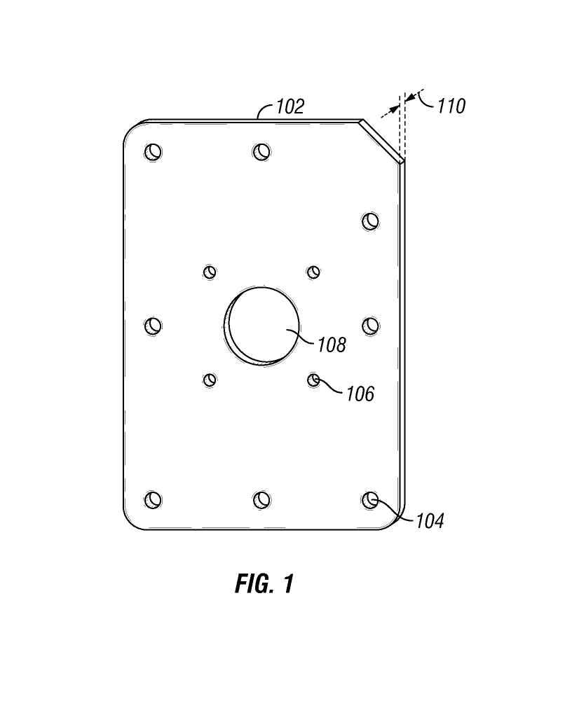

Referencing FIG. 1, an exemplary vibration dampening plate 102 is described, which may form a portion of a vibration dampening kit (not shown) for a pump. A pump, as utilized herein, includes any pump having a prime mover (power source) that drives the pump with a power take off having a driveshaft and bearings. Exemplary and non-limiting prime mover examples include an internal combustion engine and an electric motor. The internal combustion engine, if present, may be of any type understood in the art, including at least a reciprocating piston engine, a rotary engine, and a turbine engine.

The vibration dampening plate 102 includes a center shaft hole 108 sized to allow passage of a bearing shaft (not shown), or other shaft for transferring power from a prime mover to a pump. The plate 102 further includes a number of outer holes 104 sized according to a desired fastener size for affixing the plate 102 to a bulkhead (not shown). The outer holes 104 are, in one example, at least 12 mm in diameter, although any size of hole is contemplated herein. The exemplary plate 102 includes eight outer holes 104.

The plate 102 includes a number of center holes 106 that are structured to allow passage of fasteners therethrough, the fasteners coupling a bearing flange (not shown) to the bulkhead. The center holes 106 are positioned to align with the holes of the bearing flange to facilitate coupling the bearing flange to the bulkhead with the plate 102 interposed between the bulkhead and the bearing flange. The bearing flange may be a portion of a flange-wedge assembly as understood in the art.

The plate 102 further includes a thickness 110 selected to provide a selected amount of vibration dampening and structural support. An exemplary plate 102 is about 12 mm thick. In certain embodiments, the pump has tens or hundreds of kW of hydraulic pumping power, although any size pump having significant vibration in the driveline is contemplated herein. Thickness values 110 for the plate between 12 mm and 50 mm are also contemplated herein, although the thickness value 110 may be greater or less than the described range for a particular application.

An exemplary vibration dampening kit may further include a number of fasteners of a size selected according to the outer holes 104. A pump assembly without the plate 102 provided thereon may not have holes in the bulkhead (not shown) for attachment of fasteners through the outer holes 104. Accordingly, the inclusion of the fasteners for the outer holes 104 with the plate 102 facilitates the rapid installation of the plate 102. In certain embodiments, a second set of fasteners for the center holes 106 may be provided with the vibration dampening kit. For example, where the plate 102 is very thick, original fasteners with the pump assembly for coupling through the bearing flange and bulkhead may not be sufficiently long for attachment through the plate 102. Accordingly, in certain embodiments, the inclusion of the fasteners for the center holes 106 may further facilitate the rapid installation of the plate 102. Any of the described elements of a vibration dampening kit are exemplary and non-limiting.

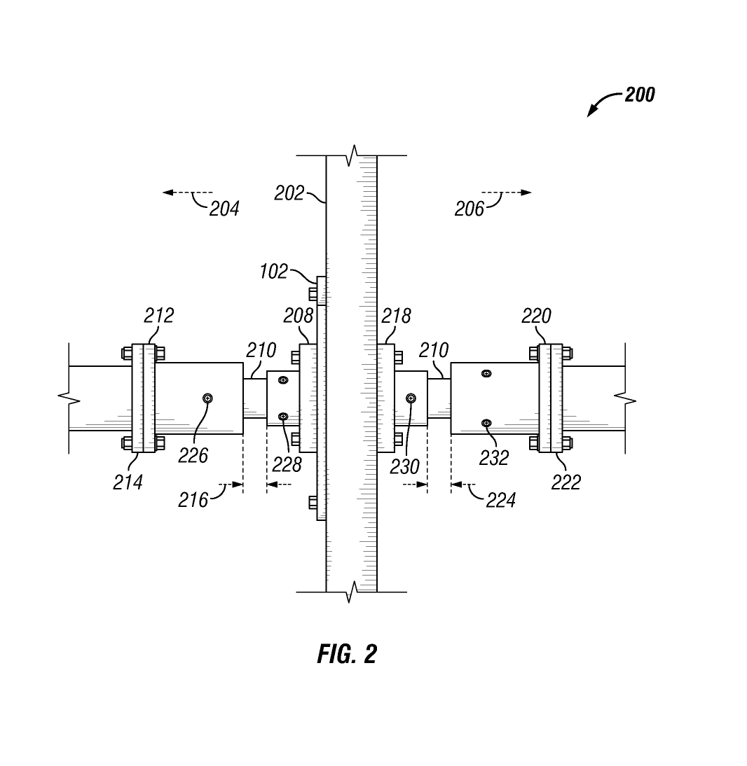

Referencing FIG. 2, an exemplary system 200 is shown including a prime-mover side 206, a pump-side 204, and a mechanical coupling therebetween. The system 200 includes a PTO-driven pump including the prime-mover side 206 and the pump-side 204, a bulkhead 202 interposed between the prime-mover side 206 and the pump-side 204, where the bulkhead includes an opening to allow passage of a bearing shaft 210 therethrough. The system 200 includes a vibration dampening plate 102 having a thickness of at least 12 mm, where the vibration dampening plate 102 is interposed between a pump-side bearing flange 208 or a prime-mover side bearing flange 218, and the bulkhead 202. The system 200 of FIG. 2 includes the plate 102 positioned between the pump-side bearing flange 208 and the bulkhead 202.

The system 200 further includes the pump-side bearing flange coupled to the bulkhead 202 through the plate 102. Each of the bearing flanges 208, 218 are coupled to the bulkhead 202 at the opening in the bulkhead 202, such that the bearing shaft 210 can pass therethrough. The system 200 includes the bearing shaft 210 extending through the opening in the bulkhead 202, the vibration dampening plate 102, and bearing flanges 208, 218. An exemplary system 200 includes the vibration dampening plate 102 including a material selected from woven glass, epoxy, a laminated material, rubber, plastic, an elastic material, and/or a composite material. Another exemplary system includes the vibration dampening plate 102 having a first number of holes positioned around the outside of the plate 102, where the vibration dampening plate 102 is coupled to the bulkhead 202 by fasteners extending through the first number of holes. A further exemplary system 200 includes the fastener each including a bolt, washer, and locknut.

Yet another exemplary system includes the vibration dampening plate 102 having a thickness between 12 mm and 50 mm. An exemplary system includes a companion flange 212, 220 coupled to a driveshaft flange 214, 222, where the system 200 includes a gap 216, 224 of at least 5 mm between the companion flange 212, 220 and the pump-side bearing flange 208 and/or the prime-mover side bearing flange 218.

Exemplary procedures to reduce vibration in a power take-off system of a pump are described. Operations described are understood to be exemplary only, and operations may be combined or divided, and added or removed, as well as re-ordered in whole or part, unless stated explicitly to the contrary herein.

A first exemplary procedure to assemble a vibration reduction plate between a bulkhead and a bearing flange of a pump engine is described following. The procedure includes an operation to place a ½″ (12.5 mm) plate onto the bulkhead, and to align a set of four center holes on the plate to corresponding holes on the bulkhead. The procedure further includes an operation to use a center punch and mark outer holes (for example, eight outer holes) to be subsequently drilled through the bulkhead to secure the plate to the bulkhead. The procedure further includes an operation to remove the plate, and to use a 27/64″ (10.7 mm) sized drill-bit to drill the holes on the bulkhead. The size of the holes and the drill-bit are selected according to the fasteners to be utilized to secure the plat e to the bulkhead. The exemplary procedure includes an operation to check the prime-mover side of bulkhead to ensure that the drill bit has a clear path prior to the drilling. The exemplary procedure further includes an operation to secure the plate to the bulkhead by first tightening fasteners through the outer holes. Exemplary fasteners include bolts, plain washers, and locknuts. Any other fastening method that includes a device to avoid backout of the fasteners is contemplated herein. The procedure further includes placing a wedge and the bearing flange on the plate, and securing the bearing flange and wedge to the bulkhead by tightening fasteners through the four center holes.

The exemplary procedure further includes an operation to loosen set screws on the bearing flange on the prime-mover side, thereby allowing a bearing shaft passing therethrough to be adjusted. The exemplary procedure further includes an operation to adjust the bearing shaft such that a gap is formed between the companion flange and the bearing flange on each side—i.e. a first gap between a pump-side companion flange and bearing flange, and a second gap between a prime-mover side companion flange and bearing flange. In certain embodiments, the operation to adjust the gaps includes providing each gap to be at least about 5 mm. The procedure includes tightening set screws on each bearing flange to fix the bearing shaft into place, inserting the companion flanges onto the bearing shaft and tightening set screws on the companion flanges, and tightening the drive shafts to the companion flanges. The order of tightening components is non-limiting, and any ordering of tightening the components is contemplated herein. In certain embodiments, one or both companion flanges are tightened to the driveshafts with 7/16″ (11 mm) bolts tightened to a torque of about 32 ft-lbs (43 nm).

A second exemplary procedure is described for installing a vibration dampening kit on a pump. The exemplary procedure includes an operation to de-couple a pump driveshaft flange from a companion flange, and an operation to de-couple a pump-side bearing flange from a bulkhead, where the bulkhead is interposed between a prime-mover side and a pump-side of a PTO-driven pump. The procedure further includes an operation to interpose a vibration dampening plate between the pump-side bearing flange and the bulkhead, and an operation to drill holes in the bulkhead aligned with a first number of holes in the vibration dampening plate. The procedure further includes an operation to couple the vibration dampening plate to a pump-side of the bulkhead with a first set of fasteners through the first number of holes. The exemplary procedure further includes an operation to couple the pump-side bearing flange to the vibration dampening plate with the second set of fasteners through the second plurality of center holes.

A further exemplary procedure includes an operation to loosen set screws on a prime-mover side bearing flange, and an operation to adjust a bearing shaft to provide a first gap between the pump-side bearing flange and the companion flange, and to provide a second gap between the prime-mover side bearing flange and a prime-mover side companion flange. In certain embodiments, the first and second gap are provided, each with a gap of at least 5 mm each.

A third exemplary procedure is described herein. The exemplary procedure includes an operation to secure a pump, including performing a lock out/tag out or other securing operation. The procedure further includes an operation to remove a set of bolts securing a driveshaft flange of a pump driveshaft from a companion flange coupling a bearing shaft to the driveshaft flange. An exemplary set of bolts securing a driveshaft flange of a pump driveshaft from a companion flange includes four 7/16″ bolts. The procedure further includes an operation to remove bolts securing a wedge and bearing flange to a bulkhead on a pump side of the bulk head. Exemplary bolts securing a wedge and bearing flange include four ½″ bolts. The procedure further includes an operation to loosen set screws on the companion flange, and to remove the companion flange from a bearing shaft. The operation to remove the companion flange may include utilizing a shaft puller.

The exemplary procedure further includes an operation to loosen set screws on the bearing flange, and to remove the wedge and bearing flange assembly. The procedure further includes an operation to position a vibration dampening plate on the bulkhead, aligning a set of center holes on the plate to holes on the bulkhead that secured the wedge and bearing flange. The procedure further includes an operation to mark on the bulkhead positions where outer holes are provided on the plate. The procedure includes an operation to check the engine side of the bulkhead to ensure drill clearance, and an operation to drill holes at the marked locations on the bulkhead. The procedure includes an operation to secure the plate to the bulkhead by tightening fasteners through the outer holes and the drilled holes on the bulkhead.

The exemplary procedure further includes an operation to secure the bearing flange to the bulkhead through the plate, for example by securing the wedge and bearing flange to the bulkhead by tightening fasteners through the center holes of the plate. The exemplary procedure further includes loosening set screws on a bearing flange on the engine side of the bulkhead, and adjusting the bearing shaft to provide a minimum gap on each side of the bearing flanges to the corresponding companion flanges. The procedure further includes an operation to tighten the set screws on each bearing flange to fix the bearing shaft into position, and an operation to position to the pump-side companion flange on the bearing shaft and tighten set screws on the companion flange. The exemplary procedure further includes an operation to couple the pump-side companion flange to the pump-side driveshaft. An exemplary coupling of the companion flange to the driveshaft includes four 7/16″ bolts tightened to 32 ft-lbs of torque.

The preceding description has been presented with reference to some embodiments. Persons skilled in the art and technology to which this disclosure pertains will appreciate that alterations and changes in the described structures and methods of operation can be practiced without meaningfully departing from the principle, and scope of this application. Accordingly, the foregoing description should not be read as pertaining only to the precise structures described and shown in the accompanying drawings, but rather should be read as consistent with and as support for the following claims, which are to have their fullest and fairest scope.

As is evident from the figures and text presented above, a variety of embodiments according to the present invention are contemplated.

An exemplary set of embodiments is a kit including a vibration dampening plate having a thickness of at least 3 mm, a first number of holes positioned around the outside of the plate, and second number of center holes positioned to interface with a bearing flange. The kit further includes a first set of fasteners having a fastener size corresponding to the first number of holes positioned around the outside of the plate, the first set of fasteners further comprising a number of fasteners at least equal to the first number of holes positioned around the outside of the plate. The exemplary kit includes the vibration dampening plate having a thickness between 12 mm and 50 mm. In certain embodiments, the first number of holes includes eight holes, and the second number of holes includes four holes. Another exemplary kit includes the vibration dampening plate formed from woven glass, epoxy, a laminated material, rubber, plastic, an elastic material, and/or a composite material.

Another exemplary set of embodiments includes a method for using a kit from the described set of exemplary embodiments of the kit. The exemplary method includes de-coupling a pump driveshaft flange from a companion flange and de-coupling a pump-side bearing flange from a bulkhead, where the bulkhead is interposed between a prime-mover side and a pump-side of a PTO-driven pump. The method includes interposing the vibration dampening plate between the pump-side bearing flange and the bulkhead, and drilling holes in the bulkhead aligned with the first number of holes. The exemplary method includes coupling the vibration dampening plate to a pump-side of the bulkhead with the first set of fasteners through the first plurality of holes, and coupling the pump-side bearing flange to the vibration dampening plate with the second set of fasteners through the second plurality of center holes.

In certain embodiments, the method further includes loosening set screws on a prime-mover side bearing flange, and adjusting a bearing shaft to provide a first gap between the pump-side bearing flange and the companion flange, and a second gap between the prime-mover side bearing flange and a prime-mover side companion flange. The provided gaps are, in an exemplary embodiment, at least 5 mm gaps.

Yet another exemplary set of embodiments is a system including a PTO-driven pump having a prime-mover side and a pump-side. The system includes a bulkhead interposed between the prime-mover side and the pump-side, with the bulkhead having an opening therein. The system includes a vibration dampening plate having a thickness of at least 12 mm, with the vibration dampening plate interposed between the bulkhead and either the pump-side bearing flange or the prime-mover side bearing flange. The pump-side bearing flange or the prime-mover side bearing flange is coupled to the bulkhead at the opening in the bulkhead. The system includes a bearing shaft extending through the opening in the bulkhead, through the vibration dampening plate, and through the pump-side bearing flange or the prime-mover side bearing flange. The bearing shaft, in certain embodiments, extends through both bearing flanges.

In certain embodiments, the system includes the vibration dampening plate being made of steel, woven glass, epoxy, a laminated material, rubber, plastic, an elastic material, and/or a composite material. In certain embodiments, the vibration dampening plate includes a first number of holes positioned around the outside of the plate, where the vibration dampening plate is coupled to the bulkhead by fasteners extending through the first number of holes. The exemplary fasteners each include a bolt, washer, and locknut.

An exemplary system includes the vibration dampening plate having a thickness between 12 mm and 50 mm. In certain embodiments, the system includes a companion flange coupled to a driveshaft flange, and the system further includes a gap of at least 5 mm between the companion flange and the bearing flange coupled to the plate. In certain embodiments, the PTO-driven pump is capable of delivering at least 10 kW and/or at least 150 kW of hydraulic pumping power.

While the invention has been illustrated and described in detail in the drawings and foregoing description, the same is to be considered as illustrative and not restrictive in character, it being understood that only certain exemplary embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Any number disclosed herein should be construed to mean approximate, regardless of whether the word “about” or “approximate” is used in describing the number.

Furthermore, none of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle. The claims as filed are intended to be as comprehensive as possible, and NO subject matter is intentionally relinquished, dedicated, or abandoned.

What is claimed is:

1. A kit, comprising:
a vibration dampening plate comprising a thickness of at least 12 mm, a first plurality of holes positioned around the outside of the plate, and second plurality of center holes positioned to interface with a bearing flange; and
a first set of fasteners comprising a fastener size corresponding to the plurality of holes positioned around the outside of the plate, the first set of fasteners further comprising a number of fasteners at least equal to the plurality of holes positioned around the outside of the plate.

2. The kit of claim 1, wherein the vibration dampening plate further comprises a thickness between 12 mm and 50 mm.

3. The kit of any one of claims 1 and 2, wherein the first plurality of holes comprises eight holes.

4. The kit of any one of claims 1 through 3, wherein the second plurality of center holes comprises four holes.

5. The kit of any one of claims 1 through 4, wherein the vibration dampening plate comprises at least one material selected from the materials consisting of: steel, woven glass, epoxy, a laminated material, rubber, plastic, an elastic material, and a composite material.

6. A method for using the kit of any one of claims 1 through 5, the method comprising:
de-coupling a pump driveshaft flange from a companion flange;
de-coupling a pump-side bearing flange from a bulkhead, the bulkhead interposed between a prime-mover side and a pump-side of a PTO-driven pump;
interposing the vibration dampening plate between the pump-side bearing flange and the bulkhead;
drilling holes in the bulkhead aligned with the first plurality of holes;
coupling the vibration dampening plate to a pump-side of the bulkhead with the first set of fasteners through the first plurality of holes; and
coupling the pump-side bearing flange to the vibration dampening plate with the second set of fasteners through the second plurality of center holes.

7. The method of claim 6, further comprising loosening set screws on a prime-mover side bearing flange, and adjusting a bearing shaft to provide a first gap between the pump-side bearing flange and the companion flange, and to provide a second gap between the prime-mover side bearing flange and a prime-mover side companion flange.

8. The method of claim 7, wherein the providing the first gap and the second gap comprises providing each gap of at least 5 mm.

9. A system, comprising:
a PTO-driven pump comprising a prime-mover side and a pump-side;
a bulkhead interposed between the prime-mover side and the pump-side, the bulkhead having an opening therein;
a vibration dampening plate comprising a thickness of at least 12 mm;
the vibration dampening plate interposed between one of a pump-side bearing flange and a prime-mover side bearing flange, and the bulkhead;
the one of the pump-side bearing flange and the prime-mover side bearing flange coupled to the bulkhead at the opening therein; and
a bearing shaft extending through the opening in the bulkhead, the vibration dampening plate, the pump-side bearing flange, and the prime-mover side bearing flange.

10. The system of claim 9, wherein the vibration dampening plate comprises at least one material selected from the materials consisting of: steel, woven glass, epoxy, a laminated material, rubber, plastic, an elastic material, and a composite material.

11. The system of any one of claims 9 and 10, wherein the vibration dampening plate includes a first plurality of holes positioned around the outside of the plate, and wherein the vibration dampening plate is coupled to the bulkhead by fasteners extending through the first plurality of holes.

12. The system claim 11, wherein the fasteners each comprise a bolt, washer, and locknut.

13. The system of any one of claims 9 through 12, wherein the vibration dampening plate further comprises a thickness between 12 mm and 50 mm.

14. The system of any one of claims 9 through 13, further comprising a companion flange coupled to a driveshaft flange, the system including a gap of at least 5 mm between the companion flange and the one of the pump-side bearing flange and the prime-mover side bearing flange.

15. The system of any one of claims 9 through 14, wherein the PTO-driven pump is capable of delivering at least 10 kW of hydraulic pumping power.

16. The system of any one of claims 9 through 14, wherein the PTO-driven pump is capable of delivering at least 150 kW of hydraulic pumping power.
